(19) United States
(12) Patent Application Publication
(10) Pub. No.: US 2026/0137084 A1
(43) Pub. Date: May 21, 2026

(54) NOVALURON MIXTURES FOR EFFICIENT INSECTICIDAL CONTROLS

(71) Applicant: ADAMA MAKHTESHIM LTD., Beer Sheva (IL)

(72) Inventors: Mariela FAURE MLYNSKI, Gedera (IL); Funda ERDOGMUS, Gaziemir, Izmir (TR)

(73) Assignee: ADAMA MAKHTESHIM LTD., Beer Sheva (IL)

(21) Appl. No.: 19/116,531

(22) PCT Filed: Sep. 28, 2023
(86) PCT No.: PCT/IL2023/051045

§ 371 Date: Mar. 28, 2025

Related U.S. Application Data
(60) Provisional application No. 63/411,652, filed on Sep. 30, 2022.

(51) Int. Cl. A01N 47/34; A01N 37/22; A01N 43/40; A01N 43/56; A01N 43/80; A01N 43/90; A01P 7/04

(52) U.S. Cl. CPC A01N 47/34; A01N 37/22; A01N 43/40; A01N 43/56; A01N 43/80; A01N 43/90; A01P 7/04

(57) ABSTRACT

The present invention relates to efficient methods of controlling insects by applying novel combinations of active compounds comprising, Novaluron and at least one further active compound in a range of effective weight ratios of the active compounds, thereby controlling the said insects.

### RELATED APPLICATION/S

This application claims benefits of U.S. Provisional Application No. 63/411,652 filed on Sep. 30, 2022; the entire content of which is hereby incorporated by reference herein. Throughout this application, various publications are cited. Disclosures of the documents and publications referred to herein are hereby incorporated in their entireties by references into this application.

### FIELD OF INVENTION

The present invention relates to efficient methods of controlling pests by applying mixture combinations of Novaluron and at least one further active compound. The invention is further directed to methods of controlling some specific insects by contacting the insect or their food supply, habitat, breeding grounds or their locus with an effective amount of the mixture combination of Novaluron and one or more additional active compounds or the composition thereof, in a range of effective weight ratios of the active compounds, so as to thereby controlling the said insects.

### BACKGROUND OF INVENTION

The vulnerability of crops to pests makes pest control one of the major management components of the total crop production system. Insects are very destructive to crop plants and can significantly reduce crop yields and quality. Insecticides help minimize this damage by controlling insect pests. Many insecticidal agents and compositions are commercially available for these purposes.

Combinations of insecticides are typically used to broaden spectrum of control, to minimize the doses of chemicals used, to retard resistance development and to reduce the cost of the treatment through additive effect. Although many combinations of insecticidal agents have been studied, a synergistic effect is rarely attained.

Further, the activity and selectivity behavior of any specific mixture is difficult to predict since the behavior of each single insecticide in the mixture is often affected by the presence of the other components and the activity of the mixture may also vary considerably depending on chemical character, plant species, growth stage, and environmental conditions. Mostly, this practice results in reduced activity of the insecticides in the mixture.

Practical agricultural experience has shown that the repeated and exclusive application of an individual active compound in the control of insect pests leads in many cases to a selection of those pests which have developed natural or adapted resistance against the active compound in question. Effective control of these pests with the active compound in question is then no longer possible.

Another difficulty in relation to the use of insecticides is that the repeated and exclusive application of an individual insecticidal compound leads in many cases, to a rapid selection of pests which have developed natural or adapted resistance against the active compound in question. Therefore, there is a need for pest control agents that help prevent or overcome resistance. In order to reduce the risk of insect pests becoming resistant to certain active compounds, mixtures of different active compounds are nowadays conventionally employed for controlling insect pests. By combining active compounds having different mechanisms of action, it is possible to ensure successful control over a relatively long period of time.

Insect growth regulators (IGR) are substances that interrupt and/or inhibit the life cycle of insect pests. IGRs include juvenile hormone mimics, ecdysone agonists and chitin synthesis inhibitors. As an insect grows, it molts, growing a new exoskeleton under its old one and then shedding the old one in order to allow the new one to swell to a new size and harden. IGRs prevent an insect from reaching maturity by interfering with the molting process. This in turn curbs infestations since the immature insects are unable to reproduce. Because IGRs work by interfering with an insect's molting process, they take longer to kill than traditional insecticides which have immediate or fast acting knockdown effects.

The active compounds mentioned herein below are known, for example, from “The Pesticide Manual”, 11thEdition, 1997, published by the British Crop Protection Council. Novaluron is described on page 888. Novaluron is a benzoylurea having the chemical formula of (+)-1-[3-chloro-4-(1,1,2-trifluoro-2-trifluoromethoxyethoxy)phenyl]-3-(2,6-difluorobenzoyl) urea. It is already known that Novaluron of the formula:

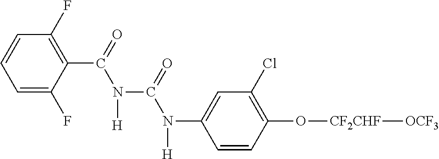

can be used for controlling animal pests, in particular insects.

Novaluron acts mainly by ingestion and contact. Novaluron disrupts post-apolytic cuticle formation, resulting in thinning of the pharate and the subsequent cuticle. This disruption of new cuticle formation leads to failed ecdysis during the molting process. Novaluron is generally used to control a wide range of pests including Lepidoptera, Coleoptera, and Diptera. The recommended application rate for Novaluron is dependent on the target pests and ranges from about 1-1000 g a.i./ha.

Arylisoxazolines, such as Fluxametamide and Isocycloseram, are γ-aminobutyric acid (GABA)-gated chloride channel allosteric modulators, that demonstrate high broad-spectrum activity against various lepidopteran, thysanopteran and dipteran pest species. Meta-diamides, such as Broflanilide, which are also GABA-gated chloride channel allosteric modulators have broad-spectrum activity (crop and non-crop pests) and can be used in different crops to control lepidoptera, coleoptera, termites, ants, cockroaches and flies.

A novel class of mesoionic pyrido[1,2-α]pyrimidinones, such as Dicloromezotiaz, has insecticidal activity controlling a number of insect species. It is a potent insecticide to control a broad range of lepidoptera.

A novel chemotype insecticide, such as Flupyrimin is effective against the major insect pests in rice, such as planthoppers and stem borers, including those populations resistant to existing insecticides. It binds to the acetylcholine site on nicotinoyl acetylcholine receptors (nAChRs), causing a range of symptoms from hyperexcitation to lethargy and paralysis in insects.

Tyclopyrazoflor is a member of the class of pyrazoles, is an organofluorine compound. It is a sap-feeding insecticidal candidate. A pyrazole carboxamide insecticide, such as Dimpropyridaz, has a pyridin-3-yl group, is effective against aphids.

Phenylpyrazole insecticide, such as Nicofluprole, is a class of chemically-related broad-spectrum insecticides, which are characterized by a central pyrazole ring with a phenyl group attached to one of the nitrogen atoms of the pyrazole.

WO 2006/048868 discloses uses of a combination of Novaluron with insecticidal compound with effective knock-down action selected from Imidacloprid and Acetamiprid, for insect control in crops and locus thereof.

WO 2007/019962 discloses insecticidal mixtures comprising Novaluron and at least one further known active compound from the group of the neonicotinoids, and to the use of these mixtures for controlling animal pests.

WO 2015/196339 discloses method of protecting rice from infestation and attack by pests and comprises contacting rice with a pesticidal composition comprising a synergistically effective amount of spinetoram and Methoxyfenozide.

It is an object of the present invention to provide mixtures and compositions which, when applied at a reduced total amount of active compounds, have improved activity against the harmful pests. It is an object of the present invention to provide a broadened activity spectrum or a combination of knock-down activity with prolonged control. It is a further object of the present invention to provide mixtures and compositions which provide effective resistance management and insect pests control, at application rates which are as low as possible.

It is an endeavor of the present invention to find that mixtures comprising Novaluron and at least one compound from the groups mentioned above are synergistically effective, being applied simultaneously, that is jointly or separately, or in succession, allows better control of insect pests than is possible with the individual compounds alone, providing synergistic results and solving at least one of the challenges in the prior art by reducing the dosage rate or enhancing the spectrum of activity or combining knock-down activity with prolonged control or facilitating resistance management.

In light of the above, there is endeavor in the present invention for methods of controlling some specific insects by contacting the insect or their food supply, habitat, breeding grounds or their locus with an effective amount of the mixture combination of Novaluron and one or more additional active compounds that exhibit synergistically enhanced action, a broader scope of activity and reduced cost of treatment.

### SUMMARY OF THE PRESENT SUBJECT MATTER

We have reasonably found that the object as described above is as a whole or in part achieved by the combination of active compounds defined below.

The present invention relates to a method of controlling insect by contacting the insect or their food supply, habitat, breeding grounds or their locus with a mixture combination comprising, as active compounds:
i) A compound I, which is Novaluron of formula (I)

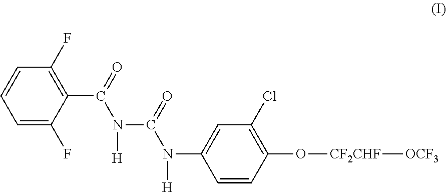

and
ii) at least one active compound II selected from the groups A.1 to A.6:
A.1. Arylisoxazolines, which are γ-aminobutyric acid (GABA)-gated chloride channel allosteric modulators, selected from the group comprising Fluxametamide and Isocycloseram.
A.2. Meta-diamides, which are GABA-gated chloride channel allosteric modulators, selected from the group comprising Broflanilide.
A.3. A mesoionic pyrido[1,2-α]pyrimidinones, selected from the group comprising Dicloromezotiaz.
A.4. A novel chemotype insecticide, selected from the group comprising Flupyrimin.
A.5. An organofluorine compound, selected from the group comprising Tyclopyrazoflor.
A.6. A Phenylpyrazole insecticide, selected from the group comprising Nicofluprole.

The present invention further specifically provides the method of controlling insect by contacting the insect or their food supply, habitat, breeding grounds or their locus with a mixture combination comprising Novaluron and at least one crop protection chemical selected from a group comprising Isocycloseram, Broflanilide, Dicloromezotiaz, Flupyrimin, Tyclopyrazoflor and Nicofluprole.

Furthermore, it is found in the present invention that simultaneous, that is jointly or separately, application of one active compound I, that is Novaluron and one or more active compounds II or successive application of Novaluron and one or more active compounds II, as mentioned above, allows enhanced control of pests compared to the control rates that are possible with the individual compounds.

The present invention provides the method of controlling insect by applying the mixture combination, wherein the weight ratio of Novaluron and one or more active compounds II, as mentioned above is from 1:1 to 1:1000.

The present invention further provides the method of controlling insect by applying pesticidal composition comprising a mixture of Novaluron and one or more active compounds II, as mentioned above, comprising an agriculturally acceptable carrier, and further comprising at least one surfactant, solid diluent, liquid diluent, or a combination thereof.

The present invention also provides a method for controlling insects, acarids or nematodes comprising contacting the insect, acarid or nematode or their food supply, habitat, breeding grounds or their locus with a pesticidally effective amount of the mixture according to the invention.

The present invention further provides a method of reducing the total amount of insecticidal active compounds necessary for controlling unwanted pests by a) applying Novaluron at an application rate from about 25% to about 75% of the recommended application rate and b) applying one or more active compounds II, as mentioned above.

This present invention also provides a method for controlling insects comprising contacting the insect or their food supply, habitat, breeding grounds or their locus with an effective amount of the mixture of Novaluron and one or more active compounds II, as mentioned above or the composition thereof, so as to thereby control insects.

The present invention further provides a method for protecting plants from attack or infestation by insects comprising contacting the plant, or the soil or water in which the plant is growing, with an effective amount of the mixture of Novaluron and one or more active compounds II, as mentioned above or the composition thereof, so as to thereby protect plants from attack or infestation by insects.

This present invention also provides a method for enhancing knock-down activity and/or prolonged control comprising contacting the plant, or the soil or water in which the plant is growing, with an effective amount of the mixture of Novaluron and one or more active compounds II, as mentioned above or the composition thereof, so as to thereby enhance knock-down activity and/or prolonged control.

This present invention further provides a method for enhancing plant development comprising applying to the plant, a locus of the plant and/or propagation material of the plant an effective amount of the mixture of Novaluron and one or more active compounds II, as mentioned above or the composition thereof, so as to thereby enhance plant development.

Furthermore, this present invention provides a method for regulating plant growth comprising applying to the plant, a locus of the plant and/or propagation material of the plant an effective amount of Novaluron and one or more active compounds II, as mentioned above or the composition thereof, so as to thereby regulate plant growth.

### DETAILED DESCRIPTION OF THE PRESENT SUBJECT MATTER

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the term “pests” is used to include animal pests, as well as harmful fungi.

As used herein, the term “AI” refers to active ingredient.

As used herein, the terms “control” or “controlling” are meant to include, but are not limited to, any killing, growth regulating, inhibiting or interfering with the normal life cycle of the pest activities of a given pest. These terms include for example preventing larvae from developing into mature insects, modulating the emergence of pests from eggs including preventing eclosion, degrading the egg material, suffocation, reducing gut motility, inhibiting the formation of chitin, disrupting mating or sexual communication, and preventing feeding activity. The terms “control” and “controlling” also include the ability to modulate or inhibit the growth or proliferation or colony formation of an organism or an organism population.

As used herein the term “knock-down activity” or “knock-down treatment” means an application of one or more insecticides for controlling insect infestation of the plant or locus before and/or after an infestation or before and/or after insect damage are shown and/or when the pest pressure is low/high. Insect pressure may be assessed based on the conditions associated with insect development such as population density and certain environmental conditions.

As used herein the term “prolonged control” means obtaining insecticidal activity over an extended period after the application of one or more insecticide for controlling insect infestation of the plant or locus over an extended period of time, before and/or after an infestation or before and/or after insect damage are shown and/or when the insect pressure is low/high. Insect pressure may be assessed based on the conditions associated with insect development such as population density and certain environmental conditions.

As used herein, the term “effective” when used to describe a method for controlling of undesired pest, such as nematodes, means that the method provides a good level of control of the undesired pest without significantly interfering with the normal growth and development of the crop.

As used herein, the term “effective amount” when used in connection with an active component refers to an amount of the active component that, when ingested, contacted with or sensed, is sufficient to achieve a good level of control or activity.

As used herein, the term “effective amount” when used in connection with a non-active component, i.e. additive, such as polymer and organic carrier, refers to an amount of the additive that is sufficient to improve the stability of the composition.

As used herein, the term “agriculturally acceptable carrier” means carrier which is known and accepted in the art for the formation of compositions for agricultural or horticultural use.

As used herein, the term “adjuvant” is broadly defined as any substance that itself is not an active ingredient, but which enhances or is intended to enhance the effectiveness of the pesticide with which it is used. Adjuvants may be understood to include, but are not limited to, spreading agents, penetrants, compatibility agents, and drift retardants.

As used herein, the term “agriculturally acceptable inert additives” is defined as any substance that itself is not an active ingredient but is added to the composition such as thickening agent, sticking agents, surfactants, anti-oxidation agent, anti-foaming agents and thickeners.

As used herein, the term “tank mix” means that two or more chemical pesticides or compositions are mixed in the spray tank at the time of spray application.

As used herein, the term “ready mix” means a composition that may be applied to plants directly after dilution. The composition comprises the combination of the active ingredients.

As used herein the term “plant” includes reference to the whole plant, plant organ (e.g., leaves, stems, twigs, roots, trunks, limbs, shoots, fruits etc.), and propagation material or plant cells.

As used herein the term “plant” includes reference to agricultural crops including field crops, vegetable crops, fruits, semi-perennial crops and perennial crops.

As used herein the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes a habitat, breeding ground, plant, propagation material, soil, area, material or environment in which a pest is growing or may grow.

As used herein the term “ha” refers to hectare.

As used herein, the term “g” refers to gram, and “L” or “I” refers to liter.

The term, “ppm” is an abbreviation for “parts per million” and it also can be expressed as milligrams per liter (mg/L). This measurement is the mass of a chemical or contaminate per unit volume of water or solvent in a formulation.

As used herein, the term “mixture” or “combination” refers, but is not limited to, a combination in any physical form, e.g., blend, solution, suspension, dispersion, emulsion, alloy, or the like.

As used herein, the term “more effective” includes, but is not limited to, increasing efficacy of pesticidal disease control, prolonging protection and reducing the amount of time needed to achieve a given level of pesticidal control, prolonging the duration of protection against pest attack after application and extending the protection period against pest attack and/or reducing the amount of time needed to achieve a level of pest control compared to when each pesticide at the same amount is applied alone.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “enhancing crop plants” as used herein means improving one or more of plant quality, plant vigor, nutrient uptake, root system, tolerance to stress factors, and/or yield in a plant to which the mixture or composition described herein has been applied as compared to a control plant grown under the same conditions except to which the mixture or composition described herein has not been applied.

The term “enhancing roots system” as used herein means the roots system is improved qualitatively or quantitatively in a plant to which the mixture or composition described herein has been applied as compared to the roots systems in a control plant grown under the same conditions except to which the mixture or composition described herein has not been applied. Enhanced roots systems include but are not limited to improved visual appearance and composition of the roots system (i.e., improved color, density, and uniformity), increased root growth, a more developed root system, stronger and healthier roots, improved plant stand, and increased roots system weight.

The term “improving plant quality” as used herein means that one or more traits are improved qualitatively or quantitatively in a plant to which the mixture or composition described herein has been applied as compared to the same trait in a control plant grown under the same conditions except to which the mixture or composition described herein has not been applied. Such traits include but are not limited to improved visual appearance and composition of the plant (i.e., improved color, density, uniformity, compactness), reduced ethylene (reduced production and/or inhibition of reception), improved visual appearance and composition of harvested material (i.e., seeds, fruits, leaves, vegetables, shoot/stem/cane), improved carbohydrate content (i.e., increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e., improved taste), improved consumer health benefits (i.e., increased levels of vitamins and antioxidants), improved post-harvest characteristics (i.e., enhanced shelf-life and/or storage stability, easier processability, easier extraction of compounds), and/or improved seed quality (i.e., for use in following seasons).

As used herein, the term “plant growth regulation” or “regulating plant growth” includes restricting vertical stem growth, promoting root growth, stunting, increasing stem diameter and stem-wall thickness, and the like.

As used herein, the term “plants” refers to any and all physical parts of a plant, including but not limited to seeds, seedlings, saplings, roots, tubers, stems, stalks, foliage, and fruits.

As used herein, the term “surfactant” means an agriculturally acceptable material which imparts emulsifiability, stability, spreading, wetting, dispersibility or other surface-modifying properties. Examples of suitable surfactants include non-ionic, anionic, cationic and ampholytic surfactants.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”.

For purposes of better understanding the present teachings and in no way limiting the scope of the teachings, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

Unless otherwise specified, references to percentages are by weight (wt.) percentages of the active compounds in the composition of this invention are based on the total weight of active ingredients in the composition, i.e., the active compounds themselves, exclusive of any amounts of solvents, carriers, dispersants, stabilizers or other materials which may be present.

It is further understood that where a parameter range is provided, all integers within that range, and tenths thereof, are also provided by the subject matter. For example, “0.1% to 50%” includes 0.1%, 0.2%, 0.3%, 0.4% etc. up to 50%.

When a ratio herein is to be “X:1 or higher”, it is meant that the ratio is Y:1, where Y is X or greater, and when a ratio is herein to be “X:1 or lower”, it is meant that the ratio is Z:1, where Z is X or less. The same logic follows for ratios that are “1:X or higher” and “1:X or lower”.

### Pesticidal Mixtures

It has been surprisingly found that by combining insecticides, insecticidal mixtures are produced, that exhibit a broad spectrum of control and high efficacy against a very wide range of insects, as well as having knock-down and long residual effect under different climate conditions. The mixtures and compositions of the present invention are based in part on the finding that application of the novel insecticidal mixture of the present invention to a locus or area where pest control is desired results in improved control of pests and prevents further infestation.

In some embodiments, the combination provides a higher insecticidal activity than that envisaged on the basis of the sum of activities of each of the insecticides found therein. Such a combination allows the reduced dosages of the individual insecticides which can damage agriculturally important plants.

In an embodiment, the present invention relates to a method of controlling insect by contacting the insect a mixture combination comprising, as active compounds:
i) a compound I, which is Novaluron, and
ii) at least one active compound II selected from the groups A.1 to A.6:
A.1. Arylisoxazolines, which are γ-aminobutyric acid (GABA)-gated chloride channel allosteric modulators, selected from the group comprising Fluxametamid and Isocycloseram.
A.2. Meta-diamides, which are GABA-gated chloride channel allosteric modulators, selected from the group comprising Broflanilide.
A.3. A mesoionic pyrido[1,2-α]pyrimidinones, selected from the group comprising dicloromezotiaz.
A.4. A novel chemotype insecticide, selected from the group comprising Flupyrimin.
A.5. An organofluorine compound, selected from the group comprising Tyclopyrazoflor.
A.6. A Phenylpyrazole insecticide, selected from the group comprising Nicofluprole.

With regard the pesticidal mixture of the present invention, the active compound II selected from group A.1 as defined above, is preferably Isocycloseram.

With regard to the pesticidal mixture of the present invention, the active compound II selected from group A.2 as defined above, is preferably Broflanilide.

With regard to the pesticidal mixture of the present invention, the active compound II selected from group A.3 as defined above, is preferably Dicloromezotiaz.

With regard to the pesticidal mixture of the present invention, the active compound II selected from group A.4 as defined above, is preferably Flupyrimin.

With regard to the pesticidal mixture of the present invention, the active compound II selected from group A.5 as defined above, is preferably Tyclopyrazoflor.

With regard to the pesticidal mixture of the present invention, the active compound II selected from group A.6 as defined above, is preferably Nicofluprole.

In one embodiment the insecticidal mixture allows enhanced control of pests is achieved compared to the control rates that are possible with the individual active compounds, wherein the said mixture is prepared by simultaneous, that is jointly or separately, application of Novaluron and one or more active compounds II or successive application of Novaluron and one or more active compounds II, as mentioned above.

In another embodiment, present invention provides the insecticidal mixture, wherein the weight ratio of Novaluron and one or more active compounds II, as mentioned above is from 1:1 to 1:1000.

In an embodiment, present invention provides the insecticidal mixture, wherein the weight ratio of Novaluron and Arylisoxazolines, which are γ-aminobutyric acid (GABA)-gated chloride channel allosteric modulators insecticide is from 1:1 to 1:1000.

In a further embodiment, present invention provides the insecticidal mixture, wherein the weight ratio of Novaluron and Isocycloseram is from 1:1 to 1:1000.

In a specific embodiment, present invention provides the insecticidal mixture, wherein the weight ratio of Novaluron and Isocycloseram is from 1:500 to 1:1000.

In an embodiment, present invention provides the insecticidal mixture, wherein the weight ratio of Novaluron and Meta-diamides, which are GABA-gated chloride channel allosteric modulators insecticide is from 1:1 to 1:1000.

In a further embodiment, present invention provides the insecticidal mixture, wherein the weight ratio of Novaluron and Broflanilide is from 1:1 to 1:1000.

In an embodiment, present invention provides the insecticidal mixture, wherein the weight ratio of Novaluron and mesoionic pyrido[1,2-α]pyrimidinones insecticide is from 1:1 to 1:1000.

In a further embodiment, present invention provides the insecticidal mixture, wherein the weight ratio of Novaluron and Dicloromezotiaz is from 1:1 to 1:1000.

In a specific embodiment, present invention provides the insecticidal mixture, wherein the weight ratio of Novaluron and Dicloromezotiaz is from 1:100 to 1:500.

In an embodiment, present invention provides the insecticidal mixture, wherein the weight ratio of Novaluron and chemotype insecticide is from 1:1 to 1:1000.

In a further embodiment, present invention provides the insecticidal mixture, wherein the weight ratio of Novaluron and Flupyrimin is from 1:1 to 1:1000.

In a specific embodiment, present invention provides the insecticidal mixture, wherein the weight ratio of Novaluron and Flupyrimin is 1:1000.

In an embodiment, present invention provides the insecticidal mixture, wherein the weight ratio of Novaluron and organofluorine compound is from 1:1 to 1:1000.

In a further embodiment, present invention provides the insecticidal mixture, wherein the weight ratio of Novaluron and Tyclopyrazoflor is from 1:1 to 1:1000.

In a specific embodiment, present invention provides the insecticidal mixture, wherein the weight ratio of Novaluron and Tyclopyrazoflor is 1:500.

In an embodiment, present invention provides the insecticidal mixture, wherein the weight ratio of Novaluron and Phenylpyrazole insecticide is from 1:1 to 1:1000.

In a further embodiment, present invention provides the insecticidal mixture, wherein the weight ratio of Novaluron and Nicofluprole is from 1:1 to 1:1000.

In a specific embodiment, present invention provides the insecticidal mixture, wherein the weight ratio of Novaluron and Nicofluprole is from 1:50 to 1:100.

In another embodiment, the present invention further provides a pesticidal composition comprising a mixture of Novaluron and one or more active compounds II, as mentioned above, comprising an agriculturally acceptable carrier, and further comprising at least one surfactant, solid diluent, liquid diluent, or a combination thereof.

In further embodiment, the present invention also provides a method for controlling insects, acarids or nematodes comprising contacting the insect, acarid or nematode or their food supply, habitat, breeding grounds or their locus with a pesticidally effective amount of the mixture according to the invention.

In an embodiment, the present invention further provides a method of reducing the total amount of insecticidal active compounds necessary for controlling unwanted pests by a) applying Novaluron at an application rate from about 25% to about 75% of the recommended application rate and b) applying one or more active compounds II, as mentioned above.

In further embodiment, this present invention also provides a method for controlling insects comprising contacting the insect or their food supply, habitat, breeding grounds or their locus with an effective amount of the mixture of Novaluron and one or more active compounds II, as mentioned above or the composition thereof, so as to thereby control insects.

In an embodiment, the present invention further provides a method for protecting plants from attack or infestation by insects comprising contacting the plant, or the soil or water in which the plant is growing, with an effective amount of the mixture of Novaluron and one or more active compounds II, as mentioned above or the composition thereof, so as to thereby protect plants from attack or infestation by insects.

In another embodiment, this present invention also provides a method for enhancing knock-down activity and/or prolonged control comprising contacting the plant, or the soil or water in which the plant is growing, with an effective amount of the mixture of Novaluron and one or more active compounds II, as mentioned above or the composition thereof, so as to thereby enhance knock-down activity and/or prolonged control.

In one of the embodiments, this present invention further provides a method for enhancing plant development comprising applying to the plant, a locus of the plant and/or propagation material of the plant an effective amount of the mixture of Novaluron and one or more active compounds II, as mentioned above or the composition thereof, so as to thereby enhance plant development.

In further embodiments, this present invention provides a method for regulating plant growth comprising applying to the plant, a locus of the plant and/or propagation material of the plant an effective amount of Novaluron and one or more active compounds II, as mentioned above or the composition thereof, so as to thereby regulate plant growth.

In another embodiment, this present invention provides a composition comprising an effective amount of Novaluron and one or more active compounds II, as mentioned above, wherein the effective amounts of both the active compounds are chosen in such a manner that the mixture thereof results in synergistic insecticidal activity.

In an embodiment, the present subject matter provides a pesticidal mixture comprising: (i) Novaluron; and (ii) an amount of Isocycloseram, wherein the mixture is more effective than (i) and/or (ii) at the same amount is applied alone.

In an embodiment, the present subject matter provides a pesticidal mixture comprising: (i) Novaluron; and (ii) an amount of Broflanilide, wherein the mixture is more effective than (i) and/or (ii) at the same amount is applied alone.

In an embodiment, the present subject matter provides a pesticidal mixture comprising: (i) Novaluron; and (ii) an amount of Dicloromezotiaz, wherein the mixture is more effective than (i) and/or (ii) at the same amount is applied alone.

In an embodiment, the present subject matter provides a pesticidal mixture comprising: (i) Novaluron; and (ii) an amount of Flupyrimin, wherein the mixture is more effective than (i) and/or (ii) at the same amount is applied alone.

In an embodiment, the present subject matter provides a pesticidal mixture comprising: (i) Novaluron; and (ii) an amount of Tyclopyrazoflor, wherein the mixture is more effective than (i) and/or (ii) at the same amount is applied alone.

In an embodiment, the present subject matter provides a pesticidal mixture comprising: (i) Novaluron; and (ii) an amount of Nicofluprole, wherein the mixture is more effective than (i) and/or (ii) at the same amount is applied alone.

In some embodiments, mixture exhibits synergistic effects.

In some embodiments, the mixture is a synergistic mixture.

In one embodiment, the present subject matter relates to a synergistic pesticidal mixture comprising: (i) Novaluron; and (ii) at least one active compound II selected from the groups A.1. A.2, A.3, A.4, A.5, and A.6 as defined above.

In some embodiments, (i) the amount of Novaluron and (ii) an amount of Arylisoxazolines, which are γ-aminobutyric acid (GABA)-gated chloride channel allosteric modulators insecticide in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount of Isocycloseram in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount of Isocycloseram in a ratio from 1:500 to 1:1000, if applied together are more effective in treating a plant or soil against insect infection than if (i) at the same amount, and (ii) at the same amount, is applied alone.

In some embodiments, (i) the amount of Novaluron and (ii) an amount of Meta-diamides, which are GABA-gated chloride channel allosteric modulators insecticide in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount of Broflanilide in a ratio from 1:1 to 1:1000, if applied together are more effective in treating a plant or soil against insect infection than if (i) at the same amount, and (ii) at the same amount, is applied alone.

In some embodiments. (i) the amount of Novaluron and (ii) an amount mesoionic pyrido[1,2-α]pyrimidinones insecticide in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount Dicloromezotiaz in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount Dicloromezotiaz in a ratio from 1:100 to 1:500, if applied together are more effective in treating a plant or soil against insect infection than if (i) at the same amount, and (ii) at the same amount, is applied alone.

In some embodiments, (i) the amount of Novaluron and (ii) an amount chemotype insecticide in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount Flupyrimin in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount Flupyrimin in a ratio of 1:1000, if applied together are more effective in treating a plant or soil against insect infection than if (i) at the same amount, and (ii) at the same amount, is applied alone.

In some embodiments, (i) the amount of Novaluron and (ii) an amount of organofluorine compound in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount of Tyclopyrazoflor in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount of Tyclopyrazoflor in a ratio of 1:500, if applied together are more effective in treating a plant or soil against insect infection than if (i) at the same amount, and (ii) at the same amount, is applied alone.

In some embodiments, (i) the amount of Novaluron and (ii) an amount of Phenylpyrazole insecticide in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount of Nicofluprole in a ratio from 1:1 to 1:1000, if applied together are more effective in treating a plant or soil against insect infection than if (i) at the same amount, and (ii) at the same amount, is applied alone.

In some embodiments, (i) the amount of Novaluron and (ii) an amount of Nicofluprole in a ratio from 1:50 to 1:100, if applied together are more effective in treating a plant or soil against insect infection than if (i) at the same amount, and (ii) at the same amount, is applied alone.

In a further embodiment, the mixture combination of active compounds of the invention comprising: (i) Novaluron; and (ii) at least one crop protection chemical compound II as defined above, is synergistically effective for controlling pests compared to when compound (i) at the same amount, and compound (ii) at the same amount, is applied alone, after several hours to several days of applications.

In an embodiment, the pesticidal mixture of the invention comprising: (i) Novaluron; and (ii) Isocycloseram, is synergistically effective for controlling pests compared to when at least one component of the mixture at the same amount is applied alone, after 120 hours of applications.

In an embodiment, the pesticidal mixture of the invention comprising: (i) Novaluron; and (ii) Broflanilide, is synergistically effective for controlling pests compared to when at least one component of the mixture at the same amount is applied alone, after 120 hours of applications.

In an embodiment, the pesticidal mixture of the invention comprising: (i) Novaluron; and (ii) Dicloromezotiaz, is synergistically effective for controlling pests compared to when at least one component of the mixture at the same amount is applied alone, after 120 hours of applications.

In an embodiment, the pesticidal mixture of the invention comprising: (i) Novaluron; and (ii) Flupyrimin, is synergistically effective for controlling pests compared to when at least one component of the mixture at the same amount is applied alone, after 120 hours of applications.

In an embodiment, the pesticidal mixture of the invention comprising: (i) Novaluron; and (ii) Tyclopyrazoflor, is synergistically effective for controlling pests compared to when at least one component of the mixture at the same amount is applied alone, after 120 hours of applications.

In an embodiment, the pesticidal mixture of the invention comprising: (i) Novaluron; and (ii) Nicofluprole, is synergistically effective for controlling pests compared to when at least one component of the mixture at the same amount is applied alone, after 120 hours of applications.

In some embodiments, the mixture reduces the amount of time needed to achieve a level of pest control compared to when at least one component of the mixture at the same amount is applied alone. An example for reduction is, if Novaluron applied alone achieves 50% insecticidal control 7 days after application, the mixture or combination disclosed herein achieves 50% insecticidal control 2 days after application where each insecticide is applied at the amount.

In some embodiments, the amount of time is reduced by at least 1 day, 2 days, 3 days, 4 day, 5 days, 7 days, 10 days, 14 days or 21 days, or 28 days.

In some embodiments, the mixture is effective for increasing plant development compared to when at least one component of the mixture at the same amount is applied alone. Increasing plant development includes, but is not limited to, enhancing the root systems, enhancing shoot of the crop plant, enhancing plant vigor and/or enhancing plant potential yield.

In some embodiments, the effectiveness is measured as increases in plant vigor, plant yield, enhancement in root system and/or enhancement in shoot.

In some embodiments, plant vigor is assessed using the relative vigor index. In some embodiments, plant vigor is increased by at least 1%, 5%, 10, 20%, 30%, 40% or 50%.

In some embodiments, enhancement in root system is measured by root weight. In some embodiments, root weight is increased by at least 1%, 5%, 10, 20%, 30%, 40% or 50%.

In some embodiments, enhancement in shoot is measured by shoot weight. In some embodiments, shoot weight is increased by at least 1%, 5%, 10, 20%, 30%, 40% or 50%.

The weight ratio between Novaluron and one of the active compound II as defined above, in the composition cannot generally be defined, as it varies depending upon various conditions such as the type of the formulation, weather conditions, the type of crop and the type of pests.

In one embodiment, the weight ratio of Novaluron to Isocycloseram in the composition is from about 1:1 to 1:1000. In a specific embodiment, the weight ratio of Novaluron to Isocycloseram is from 1:500 to 1:1000. The weight ratio of Novaluron to Isocycloseram may be an intermediate range selected from the above indicated ratios.

In one embodiment, the weight ratio of Novaluron to Broflanilide in the composition is from about 1:1 to 1:1000. The weight ratio of Novaluron to Broflanilide may be an intermediate range selected from the above indicated ratios.

In one embodiment, the weight ratio of Novaluron to Dicloromezotiaz in the composition is from about 1:1 to 1:1000. In a specific embodiment, the weight ratio of Novaluron to Dicloromezotiaz is from 1:100 to 1:500. The weight ratio of Novaluron to Dicloromezotiaz may be an intermediate range selected from the above indicated ratios.

In one embodiment, the weight ratio of Novaluron to Flupyrimin in the composition is from about 1:1 to 1:1000. In a specific embodiment, the weight ratio of Novaluron to Flupyrimin is 1:1000. The weight ratio of Novaluron to Flupyrimin may be an intermediate range selected from the above indicated ratios.

In one embodiment, the weight ratio of Novaluron to Tyclopyrazoflor in the composition is from about 1:1 to 1:1000. In a specific embodiment, the weight ratio of Novaluron to Tyclopyrazoflor is 1:500. The weight ratio of Novaluron to Tyclopyrazoflor may be an intermediate range selected from the above indicated ratios.

In one embodiment, the weight ratio of Novaluron to Nicofluprole in the composition is from about 1:1 to 1:1000. In a specific embodiment, the weight ratio of Novaluron to Nicofluprole is from 1:50 to 1:100. The weight ratio of Novaluron to Nicofluprole may be an intermediate range selected from the above indicated ratios.

Application of the inventive compositions to plants may also lead to an increase in the crop yield.

The pesticidal mixture may be applied via in furrow spray, foliar application, broadcast, basal application, soil application, soil incorporation or soil injection. The pesticidal mixtures can be applied in the early stages of the crop cycle, such as for example pre-sowing or post-sowing of the crop.

In a further embodiment, the mixture is applied in non-crop areas which include but are not limited to, commercial areas, residential areas, lawns, ornamental plants, shrubs, trees, parks, livestock areas, warehouses, food storage facilities, grain bins, turfgrass, pastures, grasslands, rangelands, fallow land, rights-of-way, golf courses, parks, along roadsides, power-lines, pipelines, railways, forests, well sites, and equipment yards.

In yet another embodiment, the plants include vegetables, such as tomatoes, peppers, cabbage, broccoli, lettuce, spinach, cauliflower, cucurbits, melon, watermelon, cucumbers, carrots, onions, potatoes, tobacco, pome and stone fruits, walnuts, kiwi, berries, olive, almonds, pineapples, apples, pears, plums, peaches, and cherries, table and wine grapes, citrus fruit, such as oranges, lemons, grapefruits and limes, cotton, soybean, oil seed rape, tree nuts, wheat, barley, maize, sorghum, sunflower, peanuts, rice, pasture, corn, coffee, beans, peas, yucca, sugar cane, clover, chili and ornamentals such as roses.

In a further embodiment, the plants include cultivated plants which tolerate the action of herbicides, fungicides or insecticides as a result of breeding and/or genetically engineered methods.

In another embodiment, the insect pests are of the order Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chactoenema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubac, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maccolaspis joliveti, Megascelis spp., Melanotus communis, Meligethes spp., Meligethes acneus (blossom beetle), Melolontha (common European cockchafer), Oberea brevis, Oberca linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cercal leaf beetle), Oulema oryzae, Pantomorus spp. (weevils), Phyllophaga spp. (May/June bectle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpocan chafer), Rhynchophorus spp. (weevils), Scolytus spp. (wood beetles), Shenophorus spp. (Billbug), Sitona lincatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In yet another embodiment, the insect pests are of the order Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranean fruit fly), Chrysops spp. (deer flies), Cocliliomyia spp. (screwworms), Contarinia spp. (Gall midges), Culex spp. (mosquitoes), Dasincura spp. (gall midges), Dasincura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

In yet another embodiment, the insect pests are of the order Hemiptera, such as Acrosternum hilare (green stink bug), Blissus leucopterus (chinch bug), Caloeoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poccilocapsus lincatus (fourlined plant bug), Psallus vaccinicola, Pseudacysta perseae, Scaptocoris castanea and Triatoma spp. (bloodsucking conenose bugs/kissing bugs).

In yet another embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginca (rosy apple aphid), Empoasca spp. (leafhoppers). Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata. Metopolophium dirhodum (rose grain aphid), Mictis longicornis, Myzus persicac (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug). Quadraspidiotus perniciosus (San Jose scale), Rhapalosiphum spp. (aphids), Rhapalosiphum maida (corn leaf aphid), Rhapalosiphum padi (oat bird-cherry aphid). Saissetia spp. (scales), Saissetia oleac (black scale), Schizaphis graminum (greenbug), Sitobion avenac (English grain aphid), Sogatella furcifera (white-backed planthopper), Therioaphis spp. (aphids). Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale), Aphis gossypii (cotton aphid) and Zulia entreriana.

In yet another embodiment, the insect pests are of the order Lepidoptera, such as Achoca janata. Adoxophyes spp., Adoxophyes orana, Agrotis spp. (cutworms), Agrotis ipsilon (black cutworm), Alabama argillacea (cotton leafworm), Amorbia cuneana. Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoncura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraca spp. (stalk borers), Diatraca saccharalis (sugarcane borer), Diatraca graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuchniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn carworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonctia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaca operculella (potato tuber moth), Phyllocnisitis citrella, Phyllonorycter spp. (leafminers), Pieris rapae (imported cabbageworm). Plathypena scabra, Plodia interpunctella (Indian meal moth), Plutella xylostella (diamondback moth), Polychrosis viteana (grape berry moth), Prays endocarpa, Prays oleac (olive moth), Pseudaletia spp. (noctuid moths), Pseudaletia unipunctata (armyworm), Pseudoplusia includens (soybean looper), Rachiplusia nu. Scirpophaga incertulas, Sesamia spp. (stemborers), Sesamia inferens (pink rice stem borer), Sesamia nonagrioides, Setora nitens, Sitotroga cercalella (Angoumois grain moth), Sparganothis pilleriana, Spodoptera spp. (armyworms), Spodoptera exigua (bect armyworm), Spodoptera littoralis (Egyptian cotton leafworm), Spodoptera frugiperda (fall armyworm), Spodoptera oridania (southern armyworm), Synanthedon spp. (root borers), Thecla basilides, Thermisia gemmatalis, Tincola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

In some specific embodiments, the insects include but not limited to Spidermites, Tetranychus urticae, H. armigera, Spodoptera spp, Helicoverpa spp., Aphis spp., A. gossypii, Myzus spp., Bemisia tabaci, Trialurodes vaporariorum, Tuta absoluta, Halyomorpha halys, Drosophila spp., S. frugiperda, M. persicae, Frankliniella occidentalis, Tetranichus spp. and Lygus spp.

The effective application rates of Novaluron, and one of the active compounds as represented as compound II as defined above, cannot generally be defined, as it varies depending upon various conditions such as the type of the formulation, weather conditions, the type of crop and the type of pests.

The application rates of the combination on the field may vary, depending on the desired effect. In an embodiment, depending on the desired effect, the application rates of the mixture according to the invention are from 1 g ai/ha to 1000 g ai/ha, particularly from 1 to 500 g ai/ha, more particularly from 1 to 100 g ai/ha.

Correspondingly, the application rates for Novaluron on the field are generally from 1 to 1000 g/ha. In some embodiments, the application rates for Novaluron are generally from 1 to 500 g/ha, particularly from 1-100 g/ha.

Correspondingly, the application rates for one of the active compounds as represented as compound II as defined above, on the field are generally from 1 to 1000 g/ha. In some embodiments, the application rates for one of the active compounds as represented as compound II as defined above are generally from 1 to 500 g/ha, particularly from 1-100 g/ha.

The present subject matter further relates to a method of reducing the total amount of insecticidal active compounds necessary for controlling unwanted pests by a) applying Novaluron at an application rate from about 25% to about 75% of the recommended application rate and b) applying one of the active compounds as represented as compound II as defined above.

That is, each of Novaluron, and the active compounds as represented as compound II as defined above, may be applied jointly or in succession. In one example, Novaluron and the active compounds as represented as compound II as defined above, are prepared separately, and the individual formulations are applied as is, or diluted to predetermined concentrations. In a further example, Novaluron and the active compounds as represented as compound II as defined above, are prepared separately, and the formulations are mixed when diluted to a predetermined concentration. In another example, Novaluron and one of the active compounds as represented as compound II as defined above, are formulated together, and the formulation is applied as it is, or the formulation is diluted to a predetermined concentration.

In some embodiments, components of the mixture or composition of the present disclosure are applied at least one time during a growth season.

In some embodiments, the components of the mixture or composition of the present disclosure are applied two or more times during a growth season.

In some embodiments, the components of the mixture or composition of the present disclosure are applied as a soil application. In some embodiments, the mixtures or compositions described herein are applied as a foliar application. In some embodiments, the components of the mixture or the composition thereof are applied as seed treatment.

In some embodiments, the composition is a synergistic composition.

In yet another embodiment, the synergistic composition may be applied in various mixtures or combinations of Novaluron, and one of the active compounds as represented as compound II as defined above, in a single “ready-for-use” form, or in a combined spray mixture composed from separate formulations of the single active ingredients, such as a “tank-mix” form.

In a further embodiment, the synergistic composition may be applied in various mixtures or combinations of Novaluron and one of the active compounds as represented as compound II as defined above, in a single “ready-for-use” form, or in a combined spray mixture composed from separate formulations of the single active ingredients, such as a “tank-mix” form.

As merely representative example, the composition is applied in the form of a ready-for-use formulation comprising Novaluron, and a diacylhydrazine insecticide (e.g. methoxyfenozide). This formulation can be obtained by combining the active ingredients in an effective amount with an agriculturally acceptable carrier, a surfactant or other application-promoting adjuvant customarily employed in formulation technology.

For a specific representative example, the composition of the present invention is preferably applied in the form of a ready-for-use formulation comprising Novaluron and methoxyfenozide, which can be obtained by combining the two active ingredients with an agriculturally acceptable carrier, a surfactant or other application-promoting adjuvant customarily employed in formulation technology.

The present composition may be employed or prepared in any conventional form, for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

According to an embodiment, the composition comprises at least one additional component selected from the group of surfactants, solid diluents and liquid diluents.

Such compositions can be formulated using agriculturally acceptable carriers, surfactants or other application-promoting adjuvants customarily employed in formulation technology and formulation techniques that are known in the art.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, cthoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, a solvent or oil, which are suitable for dilution with water.

In some embodiments, the mixture, combination, composition or synergistic mixture or composition comprises one or more additional active ingredient(s). In some embodiments, the mixture or synergistic mixture comprises one or more additional non-active ingredient(s).

The present composition may include additional crop protection agents, for example insecticides, herbicides, fungicides, bactericides, nematicides, molluscicides, growth regulators, biological agents, fertilizers, or mixtures thereof. However, for the avoidance of doubt it is understood that such additional crop protection agents are unnecessary to achieve the desired control of pests as achieved by the present combinations.

In another embodiment, the present invention provides a kit comprising a synergistic pesticidal composition as described herein, or components thereof. Such kits may comprise, in addition to the aforementioned active components, one or more additional active and/or inactive ingredients, either within the provided pesticidal composition or separately.

As noted above, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or combination) is an amount that exhibits greater pesticidal activity than the sum of the activities of the individual components.

### Method of Use

The present invention provides a method for control of insects by contacting the insect or their food supply, habitat, breeding grounds or their locus with an effective amount of any one of the mixtures or the compositions disclosed herein so as to thereby control insects.

The present invention provides a method for enhancing root systems and/or enhancing crop plants development and/or enhancing crop plants vigor and/or improving plant potential yield comprising applying an effective amount of the any one of the mixtures or compositions disclosed herein to one or more plants, the locus thereof or propagation material thereof.

The present invention provides a method for enhancing plant development comprising applying an effective amount of the any one of the mixtures or the compositions disclosed herein to one or more plants, the locus thereof or propagation material thereof so as to thereby enhance plant development.

The present invention provides a method for enhancing root system comprising applying an effective amount of the any one of the mixtures or the compositions disclosed herein to one or more plants, the locus thereof or propagation material thereof so as to thereby enhance the root system.

The present invention provides a method for enhancing plant vigor comprising applying an effective amount of the any one of the mixtures or the compositions disclosed herein to one or more plants, the locus thereof or propagation material thereof so as to thereby enhance plant vigor.

The present invention provides a method for improving plant potential yield comprising applying an effective amount of the any one of the mixtures or the compositions disclosed herein to one or more plants, the locus thereof or propagation material thereof so as to thereby improve plant potential yield.

The present invention provides a method for regulating plant growth comprising applying an effective amount of the any one of the mixtures or the compositions disclosed herein to one or more plants, the locus thereof or propagation material thereof so as to thereby regulate plant growth.

The present invention provides a method for control of insects by contacting the insect or their food supply, habitat, breeding grounds or their locus with an effective amount of the any one of the mixtures or the compositions disclosed herein so as to thereby control insects.

The present invention provides a method of protecting plants from attack or infestation by insects comprising contacting the plant, or the soil or water in which the plant is growing, with an effective amount of the any one of the mixtures or the compositions disclosed herein so as to thereby protecting plants from attack or infestation by insects.

This present invention also provides a method for enhancing knock-down activity and/or prolonged control comprising contacting the plant, or the soil or water in which the plant is growing, with an effective amount of the mixture of Novaluron and one or more active compounds II, as mentioned above or the composition thereof, so as to thereby enhance knock-down activity and/or prolonged control.

In an embodiment, this invention provides a method for controlling the insect comprising contacting the insect or their food supply, habitat, breeding grounds or their locus with an effective amount of the mixture combination of Novaluron and one or more active compounds II, as mentioned above or the composition thereof, thereby controlling the said insect.

In an embodiment, this invention provides a method for controlling the insect comprising contacting the insect or their food supply, habitat, breeding grounds or their locus with an effective amount of the mixture combination of Novaluron and one or more active compounds II, as mentioned above or the composition thereof, wherein the insect is selected from a group comprising Spidermites, Tetranychus urticae, H. armigera, Spodoptera spp, Helicoverpa spp., Aphis spp., A. gossypii, Myzus spp., Bemisia tabaci, Trialurodes vaporariorum, Tuta absoluta, Halyomorpha halys, Drosophila spp., S. frugiperda, M. persicae, Frankliniella occidentalis, Tetranichus spp. and Lygus spp.

In an embodiment, this invention provides a method for controlling the insect, S. frugiperda by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and a mesoionic pyrido[1,2-alpyrimidinone insecticide, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and a chemotype insecticide, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, S. frugiperda by contacting the insect or their food supply, habitat, breeding grounds or their locus with an effective amount of a synergistic mixture of Novaluron and Nicofluprole in a ratio from 1:1 to 1:1000, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and a Meta-diamide insecticide, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Broflanilide, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Broflanilide in a ratio from 1:1 to 1:1000, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and a mesoionic pyrido[1,2-α]pyrimidinone insecticide, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and a chemotype insecticide, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, T. urticae by contacting the insect or their food supply, habitat, breeding grounds or their locus with an effective amount of a synergistic mixture of Novaluron and Nicofluprole in a ratio from 1:1 to 1:1000, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and a Meta-diamide insecticide, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Broflanilide, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Broflanilide in a ratio from 1:1 to 1:1000, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and a mesoionic pyrido[1,2-a] pyrimidinone insecticide, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and a chemotype insecticide, so as to

In an embodiment, this invention provides a method for controlling the insect, H. armigera by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, H. armigera by contacting the insect or their food supply, habitat, breeding grounds or their locus with an effective amount of a synergistic mixture of Novaluron and Nicofluprole in a ratio from 1:1 to 1:1000, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and a Meta-diamide insecticide, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Broflanilide, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Broflanilide in a ratio from 1:1 to 1:1000, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and a mesoionic pyrido[1,2-alpyrimidinone insecticide, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and a chemotype insecticide, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, A. gossypii by contacting the insect or their food supply, habitat, breeding grounds or their locus with an effective amount of a synergistic mixture of Novaluron and Nicofluprole in a ratio from 1:1 to 1:1000, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and a Meta-diamide insecticide, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Broflanilide, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Broflanilide in a ratio from 1:1 to 1:1000, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and a mesoionic pyrido[1,2-alpyrimidinone insecticide, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and a chemotype insecticide, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, B. tabaci by contacting the insect or their food supply, habitat, breeding grounds or their locus with an effective amount of a synergistic mixture of Novaluron and Nicofluprole in a ratio from 1:1 to 1:1000, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and a Meta-diamide insecticide, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Broflanilide, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Broflanilide in a ratio from 1:1 to 1:1000, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and a mesoionic pyrido[1,2-α]pyrimidinone insecticide, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and a chemotype insecticide, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, H. halys by contacting the insect or their food supply, habitat, breeding grounds or their locus with an effective amount of a synergistic mixture of Novaluron and Nicofluprole in a ratio from 1:1 to 1:1000, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and a Meta-diamide insecticide, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Broflanilide, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Broflanilide in a ratio from 1:1 to 1:1000, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and a mesoionic pyrido[1,2-α]pyrimidinone insecticide, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and a chemotype insecticide, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, M. persicae by contacting the insect or their food supply, habitat, breeding grounds or their locus with an effective amount of a synergistic mixture of Novaluron and Nicofluprole in a ratio from 1:1 to 1:1000, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and an Arylisoxazoline insecticide, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Isocycloseram, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Isocycloseram in a ratio from 1:1 to 1:1000, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and a Meta-diamide insecticide, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Broflanilide, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Broflanilide in a ratio from 1:1 to 1:1000, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and a mesoionic pyrido[1,2-alpyrimidinone insecticide, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Dicloromezotiaz, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Dicloromezotiaz in a ratio from 1:1 to 1:1000, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and a chemotype insecticide, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Flupyrimin, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Flupyrimin in a ratio from 1:1 to 1:1000, so as to thereby controlling the said insect.

In an embodiment, this invention provides a method for controlling the insect. F. occidentalis by contacting the insect or their food supply, habitat, breeding grounds or their locus with an effective amount of a synergistic mixture of Novaluron and an organofluorine compound, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Tyclopyrazoflor, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Tyclopyrazoflor in a ratio from 1:1 to 1:1000, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and a Phenylpyrazole compound, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Nicofluprole, so as to thereby controlling the said insect.

In an embodiment, this invention provides a method for controlling the insect, F. occidentalis by contacting the insect or their food supply, habitat, breeding grounds or their locus with an effective amount of a synergistic mixture of Novaluron and Nicofluprole in a ratio from 1:1 to 1:1000, so as to thereby controlling the said insect.

The present invention also provides a method for enhancing plant growth comprising applying an effective amount of any one of the mixtures and/or compositions disclosed herein to one or more plants, the locus thereof or propagation material thereof.

In some embodiments, the mixtures and formulations of the present invention are applied as a knock-down treatment.

In some embodiments, the mixtures and formulations of the present invention are applied to provide prolonged insecticidal control.

The following examples illustrate the practice of the present invention in some of its embodiments but should not be construed as limiting the scope of the invention. Other embodiments will be apparent to one skilled in the art from consideration of the specification and examples. It is intended that the specification, including the examples, is considered exemplary only without limiting the scope and spirit of the invention.

### Examples

Representative experiments were carried out to determine the synergistic effect of the mixture combination which comprises a mixture of i) Novaluron and ii) a crop protection chemical compound such as Isocycloseram, Dicloromezotiaz, Flupyrimin, Tyclopyrazoflor and Nicofluprole.

A mixture combination may be prepared by thoroughly mixing commercially available Novaluron (weight %) with a crop protection chemical compound, which is commercially available, such as Isocycloseram, Dicloromezotiaz, Flupyrimin, Tyclopyrazoflor and Nicofluprole (weight %).

Different concentrations of each of the active ingredients are applied to different species of insects. The percent controls are determined sometime after treatment.

A synergistic effect exists whenever the action of a combination of active ingredients is greater than the sum of the action of each of the ingredients alone. Therefore, a synergistic combination is a combination of active ingredients having an action that is greater than the sum of the action of each active ingredient alone, and a synergistically effective amount is an effective amount of a synergistic combination.

Colby's method, is used to determine if synergy exists for a combination of active ingredients. According to Colby, the expected action (E) of active ingredients A+B is:

$$E = A + B - ( \frac{AB}{100} )$$

where E=expected efficacy, A and B=the efficacy of two active ingredients A and B at a given dose.

When the percentage of control observed (O) for the combination is greater than the expected (E) percentage, there is a synergistic effect. The synergism ratio (R) is calculated as the ratio between the expected values and observed values. If the synergism ratio (R) between observed and expected is >1 then synergy is exhibited, if R=1 then the effect is additive and if R<1 then the mix is antagonistic.

For a more detailed description of the Colby formula, see Colby, S. R. “Calculating synergistic and antagonistic responses of herbicide combination,” Weeds, Vol. 15, pages 20-22; 1967; see also Limpel et al., Proc. NEWCC 16:48-53 (1962).

The insecticidal compounds A (Novaluron) and B (mix partner) are formulated as equivalent compositions to eliminate the effects of differing formulation inerts on biological activity. Efficacy of the insecticidal compositions is evaluated with reference to a scale of 0% to 100% in comparison with untreated control plots. 0 means no damage and 100 means complete destruction of the harmful pests.

The experiments were conducted by applying commercially available formulations of Novaluron and other mixture partners, alone or with their tank-mixed compositions with the same weight ratio. The compositions were diluted with water or some other suitable solvents to the stated concentration of the active compounds.

Each formulation with active ingredient is diluted with water or other suitable solvent(s) to the ppm (parts per million) level and biological efficacy trials on pests are conducted.

following experimentations were done with various mixtures of Novaluron on different types of pests, the result of which are summarized in the below tables:

TABLE 1
Novaluron + Isocycloseram against S. frugiperda
Synergistic activity of a Novaluron + Isocycloseram
against S. frugiperda, 120 hours after treatment

| Active | | Observed % | Expected % | Synergism |
|---|---|---|---|---|
| ingredient | Rate (ppm) | control (O) | control (E) | ratio (R) |
| Novaluron | 0.01 | 16 | — | — |
| Isocycloseram | 5 | 20 | — | — |
| Isocycloseram | 10 | 20 | — | — |
| Novaluron + | 0.01 + 5 | 60 | 32.8 | 1.83 |
| Isocycloseram | | | | |
| Novaluron + | 0.01 + 10 | 70 | 32.8 | 2.13 |
| Isocycloseram | | | | |

TABLE 2
Novaluron + Dicloromezotiaz against S. frugiperda
Synergistic activity of a Novaluron + Dicloromezotiaz
against S. frugiperda, 120 hours after treatment

| Active | | Observed % | Expected % | Synergism |
|---|---|---|---|---|
| ingredient | Rate (ppm) | control (O) | control (E) | ratio (R) |
| Novaluron | 0.01 | 16 | — | — |
| Dicloromezotiaz | 1 | 0 | — | — |
| Dicloromezotiaz | 2.5 | 40 | — | — |
| Dicloromezotiaz | 5 | 20 | — | — |
| Novaluron + | 0.01 + 1 | 60 | 16 | 3.75 |
| Dicloromezotiaz | | | | |
| Novaluron + | 0.01 + 2.5 | 80 | 49.6 | 1.61 |
| Dicloromezotiaz | | | | |
| Novaluron + | 0.01 + 5 | 100 | 32.8 | 3.05 |
| Dicloromezotiaz | | | | |

TABLE 3
Novaluron + Flupyrimin against S. frugiperda
Synergistic activity of a Novaluron + Flupyrimin
against S. frugiperda, 120 hours after treatment

| Active | | Observed % | Expected % | Synergism |
|---|---|---|---|---|
| ingredient | Rate (ppm) | control (O) | control (E) | ratio (R) |
| Novaluron | 0.01 | 16 | — | — |
| Flupyrimin | 10 | 10 | — | — |
| Novaluron + | 0.01 + 10 | 40 | 24.4 | 1.64 |
| Flupyrimin | | | | |

TABLE 4
Novaluron + Tyclopyrazoflor against S. frugiperda
Synergistic activity of a Novaluron + Tyclopyrazoflor
against S. frugiperda, 120 hours after treatment

| Active | | Observed % | Expected % | Synergism |
|---|---|---|---|---|
| ingredient | Rate (ppm) | control (O) | control (E) | ratio (R) |
| Novaluron | 0.01 | 16 | — | — |
| Tyclopyrazoflor | 5 | 20 | — | — |
| Novaluron + | 0.01 + 5 | 100 | 32.8 | 3.05 |
| Tyclopyrazoflor | | | | |

TABLE 5
Novaluron + Nicofluprole against S. frugiperda
Synergistic activity of a Novaluron + Nicofluprole
against S. frugiperda, 120 hours after treatment

| Active | | Observed % | Expected % | Synergism |
|---|---|---|---|---|
| ingredient | Rate (ppm) | control (O) | control (E) | ratio (R) |
| Novaluron | 0.01 | 16 | — | — |
| Nicofluprole | 0.5 | 20 | — | — |
| Nicofluprole | 1 | 40 | — | — |
| Novaluron + | 0.01 + 0.5 | 100 | 32.8 | 3.05 |
| Nicofluprole | | | | |
| Novaluron + | 0.01 + 1 | 100 | 24.4 | 4.1 |
| Nicofluprole | | | | |

TABLE 6
Novaluron + Isocycloseram against H. armigera
Synergistic activity of a Novaluron + Isocycloseram
against H. armigera, 120 hours after treatment

| Active | | Observed % | Expected % | Synergism |
|---|---|---|---|---|
| ingredient | Rate (ppm) | control (O) | control (E) | ratio (R) |
| Novaluron | 0.2 | 20 | — | |
| Isocycloseram | 10 | 20 | — | |
| Isocycloseram | 20 | 50 | — | |
| Novaluron + | 0.2 + 10 | 55 | 36 | 1.53 |
| Isocycloseram | | | | |
| Novaluron + | 0.2 + 20 | 100 | 64 | 1.56 |
| Isocycloseram | | | | |

TABLE 7
Novaluron + Dicloromezotiaz against H. armigera
Synergistic activity of a Novaluron + Dicloromezotiaz
against H. armigera, 120 hours after treatment

| Active | | Observed % | Expected % | Synergism |
|---|---|---|---|---|
| ingredient | Rate (ppm) | control (O) | control (E) | ratio (R) |
| Novaluron | 0.1 | 20 | — | — |
| Dicloromezotiaz | 40 | 40 | — | — |
| Novaluron + | 0.1 + 40 | 100 | 52 | 1.92 |
| Dicloromezotiaz | | | | |

TABLE 8
Novaluron + Nicofluprole against H. armigera
Synergistic activity of a Novaluron + Nicofluprole
against H. armigera, 120 hours after treatment

| Active | | Observed % | Expected % | Synergism |
|---|---|---|---|---|
| ingredient | Rate (ppm) | control (O) | control (E) | ratio (R) |
| Novaluron | 0.1 | 20 | — | — |
| Nicofluprole | 5 | 30 | — | — |
| Novaluron + | 0.1 + 5 | 100 | 44 | 2.27 |
| Nicofluprole | | | | |

TABLE 9
Novaluron + Tyclopyrazoflor against H. armigera
Synergistic activity of a Novaluron + Tyclopyrazoflor
against H. armigera, 120 hours after treatment

| Active | | Observed % | Expected % | Synergism |
|---|---|---|---|---|
| ingredient | Rate (ppm) | control (O) | control (E) | ratio (R) |
| Novaluron | 0.1 | 20 | — | — |
| Tyclopyrazoflor | 160 | 20 | — | — |
| Novaluron + | 0.1 + 160 | 100 | 36 | 2.77 |
| Tyclopyrazoflor | | | | |

S. frugiperda and H. armigera have been chosen merely as a representative target pest. While the examples have been shown and described with reference to preferred embodiments thereof, it will be understood by those skilled in the art that many alternatives, modifications and variations may be made thereto without departing from the spirit and scope thereof. Accordingly, it is intended to embrace all such alternatives, modifications, and variations that fall within the spirit and broad scope of the appended claims.

What is claimed is:

1. A method for controlling insects comprising contacting the insect or their food supply, habitat, breeding grounds or their locus with an effective amount of a mixture combination comprising, as active compounds:
i) A compound I, which is Novaluron of formula (I) 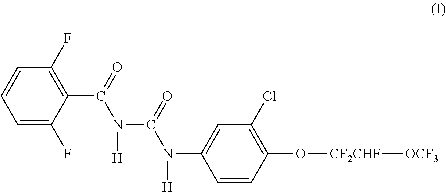
and
ii) at least one active compound II selected from the groups A.1 to A.6:
A.1. Arylisoxazolines, which are γ-aminobutyric acid (GABA)-gated chloride channel allosteric modulators, selected from the group comprising Fluxametamid and Isocycloseram;
A.2. Meta-diamides, which are GABA-gated chloride channel allosteric modulators, selected from the group comprising Broflanilide;
A.3. A mesoionic pyrido[1,2-α]pyrimidinones, selected from the group comprising Dicloromezotiaz;
A.4. A novel chemotype insecticide, selected from the group comprising Flupyrimin;
A.5. An organofluorine compound, selected from the group comprising Tyclopyrazoflor;
A.6. A Phenylpyrazole insecticide, selected from the group comprising Nicofluprole.

2. The method for controlling insects according to claim 1, wherein the insects are selected from a group comprising T. urticae, H. armigera, A. gossypii, B. tabaci, H. halys, S. frugiperda, M. persicae and F. occidentalis.

3. The method of any one of the claims 1-2 for controlling the insects, wherein the mixture combination is selected from the group comprising:
a) Novaluron and an arylisoxazoline
b) Novaluron and a meta-diamide
c) Novaluron and a mesoionic pyrido[1,2-α]pyrimidinone
d) Novaluron and a chemotype insecticide
e) Novaluron and an organofluorine compound
f) Novaluron and a phenylpyrazole insecticide.

4. The method of any one of the claims 1-3 for controlling the insects, wherein the mixture combination is selected from the group comprising:
i) Novaluron and Isocycloseram,
ii) Novaluron and Broflanilide,
iii) Novaluron and Dicloromezotiaz,
iv) Novaluron and Flupyrimin,
v) Novaluron and Tyclopyrazoflor, and
vi) Novaluron and Nicofluprole.

5. The method of any one of the claims 1-4 for controlling the insects, wherein the mixture combination exhibits synergistic effects.

6. The method of any one of the claims 1-5 for controlling the insects, wherein Novaluron and at least one active compound II as defined in claim 1, are applied jointly or in a succession.

7. The method of any one of the claims 1-5 for controlling the insects, wherein the weight ratio of Novaluron and one active compound II as defined in claim 1, is from 1:1 to 1:1000.

8. The method of any one of the claims 1-2 for controlling the insects, wherein the mixture combination is further comprising at least an agriculturally acceptable carrier.

9. The method for controlling insects comprising contacting the insect or their food supply, habitat, breeding grounds or their locus with an effective amount of the mixture according to any one of claims 1-7 or the composition according to claim 8 so as to thereby control insects.

10. The method of claim 9 for controlling the insect, S. frugiperda by contacting the insect or their food supply, habitat, breeding grounds or their locus with an effective amount of a synergistic mixture of novaluron and an Arylisoxazoline, which is a γ-aminobutyric acid (GABA)-gated chloride channel allosteric modulator, as defined in claim 1, in a ratio from 1:1 to 1:1000, so as to thereby controlling the said insect.

11. The method of claim 9 for controlling the insect, S. frugiperda by contacting the insect or their food supply, habitat, breeding grounds or their locus with an effective amount of a synergistic mixture of novaluron and a Meta-diamide, which is GABA-gated chloride channel allosteric modulator, as defined in claim 1, in a ratio from 1:1 to 1:1000, so as to thereby controlling the said insect.

12. The method of claim 9 for controlling the insect, S. frugiperda by contacting the insect or their food supply, habitat, breeding grounds or their locus with an effective amount of a synergistic mixture of novaluron and a mesoionic pyrido[1,2-α]pyrimidinone, as defined in claim 1, in a ratio from 1:1 to 1:1000, so as to thereby controlling the said insect.

13. The method of claim 9 for controlling the insect, S. frugiperda by contacting the insect or their food supply, habitat, breeding grounds or their locus with an effective amount of a synergistic mixture of novaluron and a chemotype insecticide, as defined in claim 1, in a ratio from 1:1 to 1:1000, so as to thereby controlling the said insect.

14. The method of claim 9 for controlling the insect, S. frugiperda by contacting the insect or their food supply, habitat, breeding grounds or their locus with an effective amount of a synergistic mixture of novaluron and an organofluorine compound, as defined in claim 1, in a ratio from 1:1 to 1:1000, so as to thereby controlling the said insect.

15. The method of claim 9 for controlling the insect, S. frugiperda by contacting the insect or their food supply, habitat, breeding grounds or their locus with an effective amount of a synergistic mixture of novaluron and a Phenylpyrazole insecticide, as defined in claim 1, in a ratio from 1:1 to 1:1000, so as to thereby controlling the said insect.

16. The method of claim 9 for controlling the insect, H. armigera by contacting the insect or their food supply, habitat, breeding grounds or their locus with an effective amount of a synergistic mixture of novaluron and an Arylisoxazoline, which is a γ-aminobutyric acid (GABA)-gated chloride channel allosteric modulator, as defined in claim 1, in a ratio from 1:1 to 1:1000, so as to thereby controlling the said insect.

17. The method of claim 9 for controlling the insect, H. armigera by contacting the insect or their food supply, habitat, breeding grounds or their locus with an effective amount of a synergistic mixture of novaluron and a Meta-diamide, which is GABA-gated chloride channel allosteric modulator, as defined in claim 1, in a ratio from 1:1 to 1:1000, so as to thereby controlling the said insect.

18. The method of claim 9 for controlling the insect, H. armigera by contacting the insect or their food supply, habitat, breeding grounds or their locus with an effective amount of a synergistic mixture of novaluron and a mesoionic pyrido[1,2-α]pyrimidinone, as defined in claim 1, in a ratio from 1:1 to 1:1000, so as to thereby controlling the said insect.

19. The method of claim 9 for controlling the insect, H. armigera by contacting the insect or their food supply, habitat, breeding grounds or their locus with an effective amount of a synergistic mixture of novaluron and a chemotype insecticide, as defined in claim 1, in a ratio from 1:1 to 1:1000, so as to thereby controlling the said insect.

20. The method of claim 9 for controlling the insect, H. armigera by contacting the insect or their food supply, habitat, breeding grounds or their locus with an effective amount of a synergistic mixture of novaluron and an organofluorine compound, as defined in claim 1, in a ratio from 1:1 to 1:1000, so as to thereby controlling the said insect.

21. The method of claim 9 for controlling the insect, H. armigera by contacting the insect or their food supply, habitat, breeding grounds or their locus with an effective amount of a synergistic mixture of novaluron and a Phenylpyrazole insecticide, as defined in claim 1, in a ratio from 1:1 to 1:1000, so as to thereby controlling the said insect.
